(19) United States
(12) Patent Application Publication
(10) Pub. No.: US 2010/0014284 A1
(43) Pub. Date: Jan. 21, 2010

(54) Multipurpose Flashlight

(76) Inventors: Jeffery D. Hancock, Uintah, UT (US); Dennis Hancock, Morgan, UT (US)

Correspondence Address: Timothy B. Smith, Suite 800, 185 South State Street, Salt Lake City, UT, 84111, US

(21) Appl. No.: 12/460,240

(22) Filed: Jul. 15, 2009

Related U.S. Application Data
(60) Provisional application No. 61/081,323, filed on Jul. 16, 2008.

(51) Int. Cl. F21L 4/04; F23Q 1/06; B24B 33/08

(52) U.S. Cl. 362/205; 431/273; 451/556

(57) ABSTRACT

A multipurpose flashlight comprising a slotted locking donut and insert stick that can be used to start a fire. The multipurpose flashlight provides an easy way for an individual to have all the tools they will need to create a fire in a survival situation or anytime they are participating in outdoor activities.

### CROSS REFERENCE TO RELATED APPLICATION

This application claims the benefit of U.S. Provisional Application Ser. No. 61/081,323 filed Jul. 16, 2008 by Dennis Hancock and Jeffery D. Hancock.

### FIELD OF THE INVENTION

The present invention relates generally to flashlights and more particularly a multipurpose survival flashlight.

### BACKGROUND OF THE INVENTION

When an individual is engaging in outdoor activities such as camping, hiking, hunting, fishing, etc., they will almost always carry a flashlight. They do not, however, always carry necessary materials they will need in the event they become lost, injured or find themselves in a survival situation and need to start a fire. This is often because the individual does not believe they will end up in a survival situation or believe that they do not have room to carry or store additional equipment. There is clearly a need to provide individuals engaging in outdoor activities with an easy way to be prepared in a survival situation where they can easily remember and access their survival materials.

### SUMMARY OF THE INVENTION

The present invention has been accomplished to provide a multipurpose flashlight that can be used as device for illumination and a device for starting a fire.

According to the present invention, there is provided a multipurpose flashlight, which is generally comprised of at least one light bulb, a barrel that defines a battery compartment for holding at least one battery, an electrical switch mounted to the barrel, and an end cap that incorporates a slotted locking donut. The slotted locking donut structure and insert sticks of the present invention permits the user to carry materials they will need in a survival situation. When put in a position of surviving a night outdoors without any lighter or matches, one must be able to start a fire in other ways. One such way is to use a flint. The novel slotted locking donut of the present invention is designed to cover several slots that run along the length of the multipurpose flashlight. Within each of these slots can be incorporated materials an individual can use to start a fire without matchers or a lighter. One slot may include a flint; one slot may include a striker for hitting against the flint to create a spark; one slot may include a piece of magnesium, which can be shaved to create a small pile of magnesium that will ignite when hit by a spark; one slot may contain ceramic for sharpening the blade of knife. A knife sharpener can also be incorporated into one of the insert sticks. The slotted locking donut can be rotated to permit access to the various exterior slots allowing the user to pull out and use the various survival tools.

In one aspect of the invention, it provides a flashlight for illumination.

In another aspect of the invention, it provides a means for starting a fire.

In another aspect of the invention, it provides a means for starting a fire when matches or a lighter are not available.

In another aspect of the invention, it provides a means for sharpening knives and other tools that require sharp edges.

In another aspect of the invention, it provides a means for easily securing and carrying material that can be used in a survival situation.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a perspective view of the present invention.

FIG. 2 is an exploded perspective view of the present invention.

FIG. 3 is a side view of the barrel of the present invention without the slotted locking donut or end cap.

FIG. 4 is a perspective view of the barrel of the present invention without the slotted locking donut or end cap.

FIG. 5 is a bottom view of the barrel of the present invention without the slotted locking donut or end cap.

FIG. 6 is a perspective view of the barrel of the present invention with the slotted locking donut in place.

FIG. 7 is a bottom view of the barrel with the slotted locking donut in place.

FIG. 8 is a bottom view of the present invention.

FIG. 9 is a perspective view of the striker stick of the present invention.

FIG. 10 is a side view of the striker stick of the present invention.

FIG. 11 is a bottom view of the striker stick of the present invention.

### DETAILED DESCRIPTION OF THE INVENTION

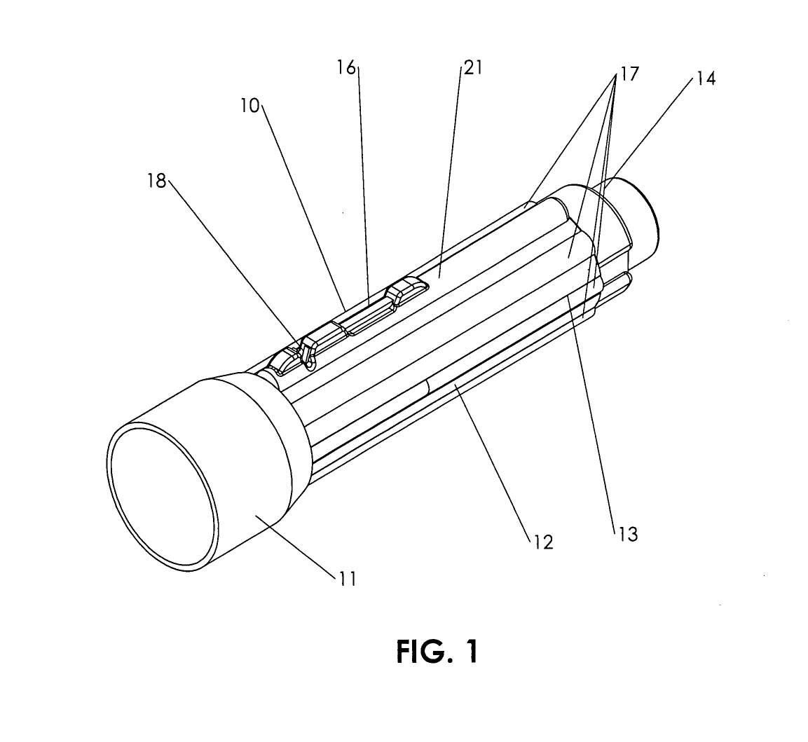

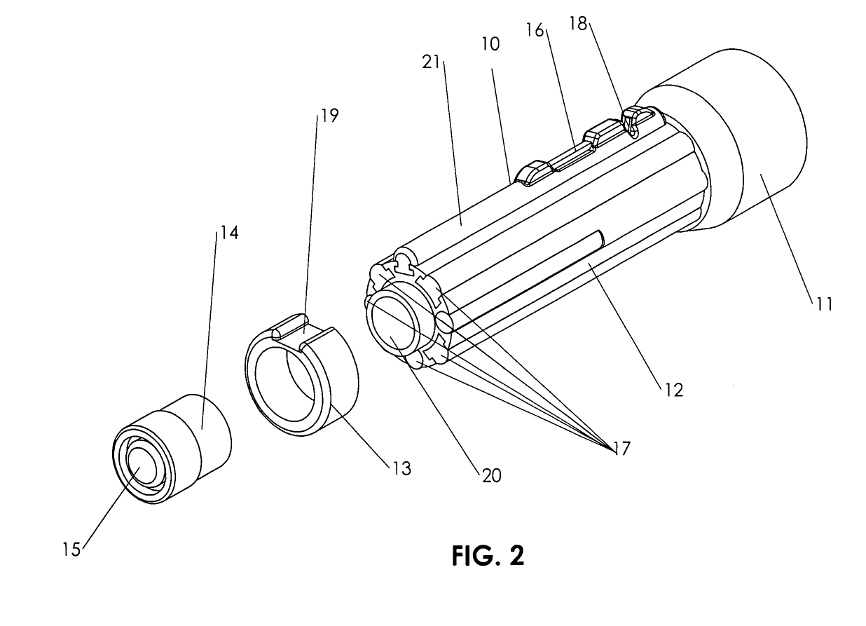

Referring to FIGS. 1 and 2, a multipurpose flashlight 10 in accordance with the present invention comprises a lamp head 11 containing at least one light bulb, a barrel 12, a slotted locking donut 13, end cap 14, ON/OFF switch 15, striker 16 and insert sticks 17. Insert sticks 17 are contained within utility channels 22 and may be made out of a variety of materials including flint, magnesium, ceramic or rubber. Multipurpose flashlight 10 may also include knife sharpener 18. Knife sharpener 18 can be used while in its utility channel 22 on barrel 12 or may be removed and used independently from multipurpose flashlight 10.

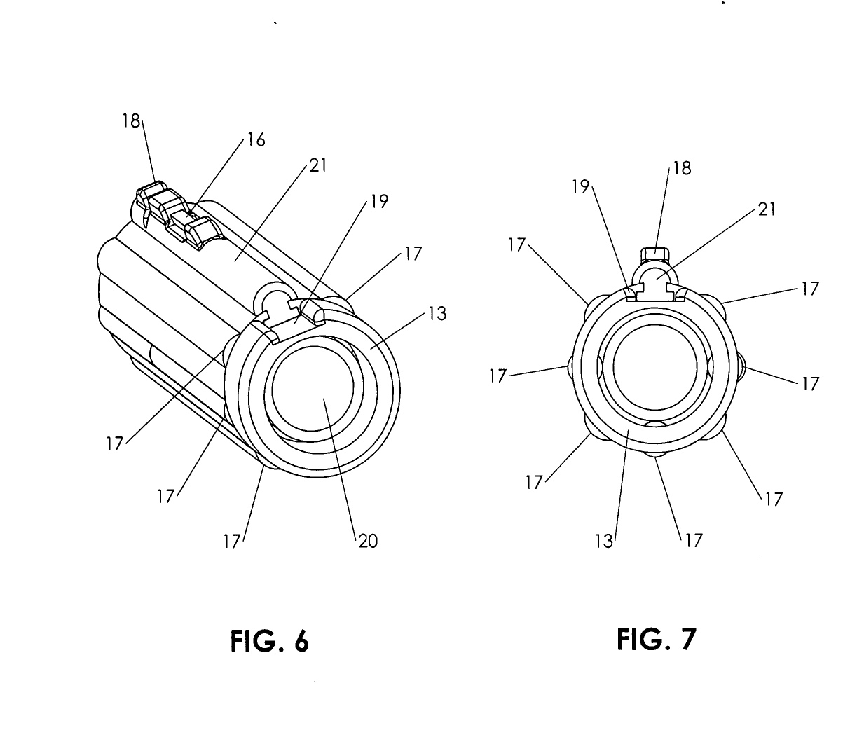

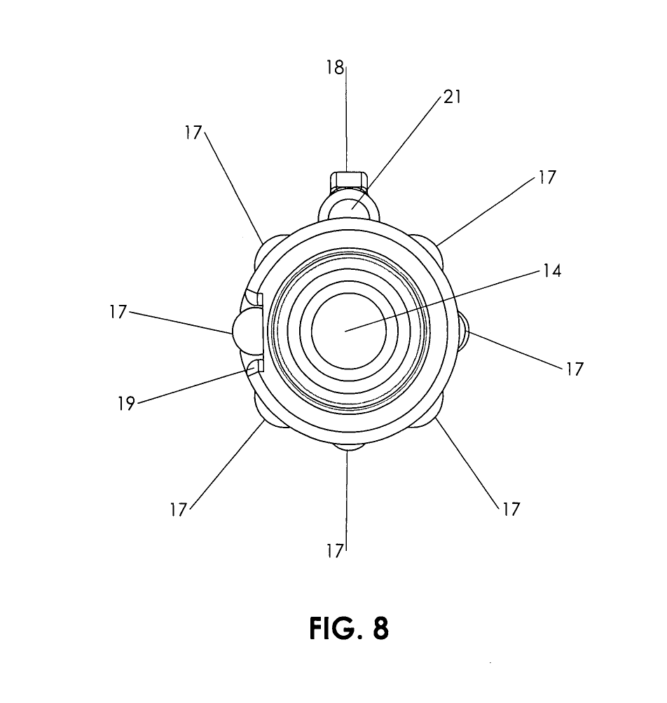

Slotted locking donut 13 can be rotated such that slot 19 is over striker stick 21 as shown in FIGS. 6 through 8. This permits the user to remove striker stick 21 from barrel 12 so striker 16 can be used to start a fire by being struck against a flint or other object creating a spark. Striker 16 can also be used to shave off small pieces of magnesium to use in starting a fire. Slotted locking donut 13 can also be positioned in front of insert stick 17 to be struck to avoid having striker 16 impact slotted locking donut 13. When end cap 14 is screwed in tightly to barrel 12, slotted locking donut 13 is compressed into striker stick 21 and insert sticks 17 locking them into place. When end cap 14 is removed insert sticks 17 can be rotated enabling the user to use entire surface of a flint or magnesium insert stick. Additionally, when end cap 14 is completely removed from barrel 12 battery compartment 20 can be accessed and slotted locking donut 13 removed.

When end cap 14 and slotted locking donut 13 are removed from barrel 12, striker stick 21 and insert sticks 17 can be removed or replaced. Thus, striker stick 21 and insert sticks 17 can be removed and used separately from multipurpose flashlight 10. This becomes important if someone is trying to start a fire in the dark. Striker stick 21 and insert sticks 17 can be removed and held in front of the light generated by multipurpose flashlight 10. The user can then use striker 16 to create magnesium shavings, into which the user can direct a spark using striker 16 and a flint.

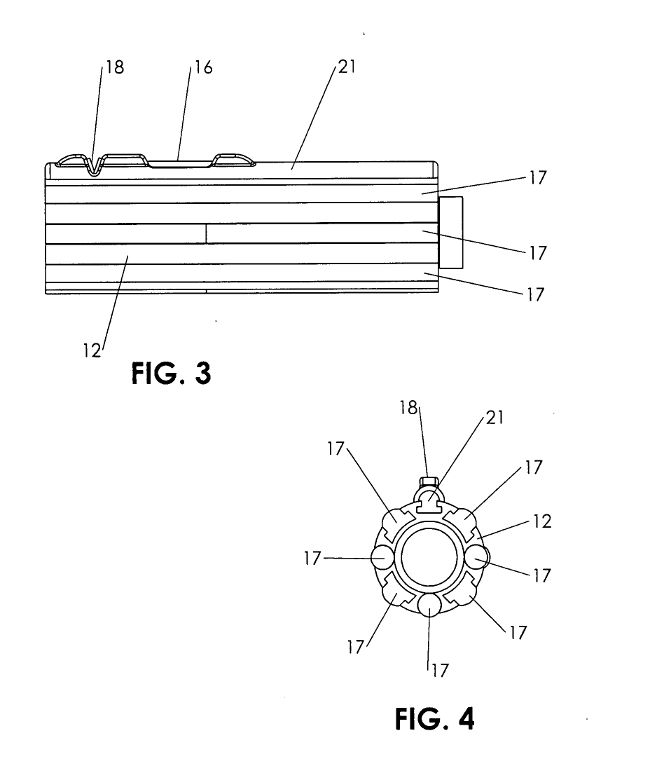

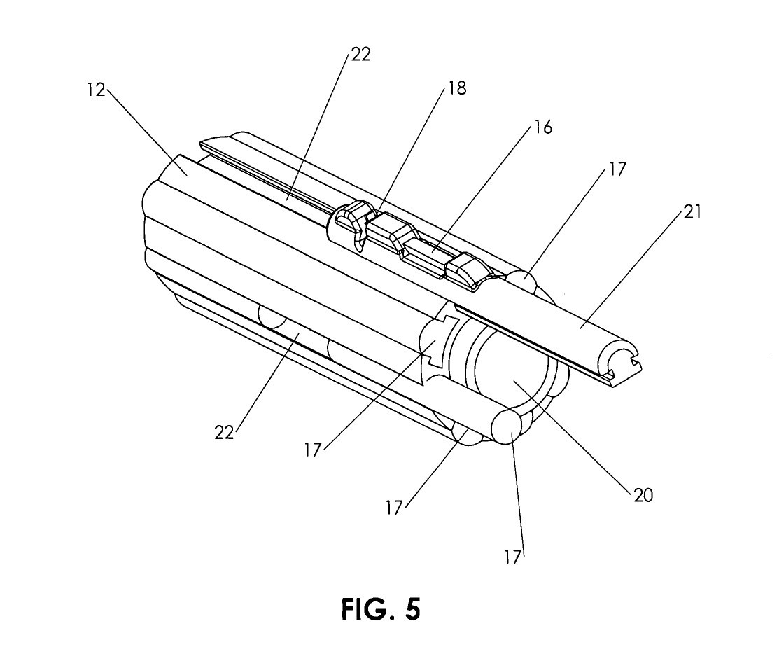

FIGS. 3 through 5 show barrel 12 without end cap 14, slotted locking donut 13 or lamp head 11. When end cap 14 and slotted locking donut 13 are removed from barrel 12, striker stick 21 and insert sticks 17 are easily accessible to the user.

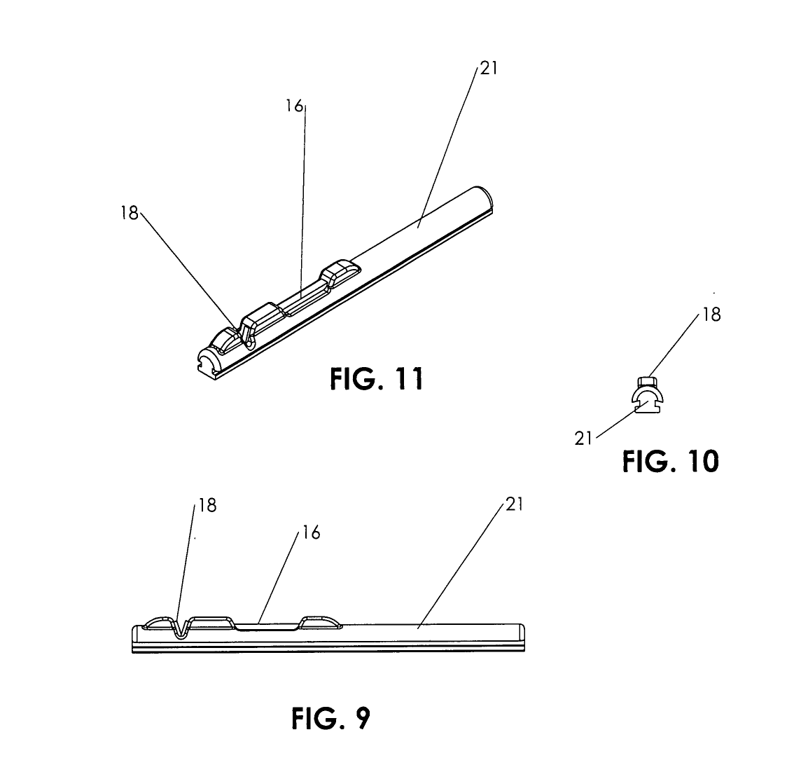

Referring to FIGS. 9 through 11, striker stick 21 must be removed from barrel 12 in order to permit use of striker 16 against a flint or to create magnesium shavings.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

1. A multipurpose flashlight comprising:
a light source;
a casing, wherein said casing defines a battery chamber and at least one utility channel;
a removable end cap;
a slotted locking donut;
an insert stick located within said utility channel; and
an electrical switch means.

2. A multipurpose flashlight comprising:
a light source;
a casing, wherein said casing defines a battery chamber and a plurality of utility channels;
a removable end cap;
a slotted locking donut;
an insert stick made of flint;
a striker; and
an electrical switch means.

3. The multipurpose flashlight of claim 2 wherein said casing is comprised of a lamp head and a barrel, said barrel containing a plurality of utility channels.

4. The multipurpose flashlight of claim 2 wherein said insert stick and said striker can be removed from said casing.

5. The multipurpose flashlight of claim 2 wherein there is a plurality of insert sticks located within said utility channels.

6. The multipurpose flashlight of claim 5 wherein there is an insert stick made of magnesium.

7. The multipurpose flashlight of claim 5 wherein an insert stick contains a knife sharpener.

8. The multipurpose flashlight of claim 2 wherein said striker is located on one of said insert sticks.
